(19) United States
(12) Patent Application Publication
(10) Pub. No.: US 2016/0104124 A1
(43) Pub. Date: Apr. 14, 2016

(54) Systems and Methods for Fleet Maintenance Management

(71) Applicant: Caterpillar Inc., Peoria, IL (US)

(72) Inventor: Robert Gerald Bullock, Germantown Hills, IL (US)

(73) Assignee: CATERPILLAR INC., Peoria, IL (US)

(21) Appl. No.: 14/511,762

(22) Filed: Oct. 10, 2014

(51) Int. Cl. G06Q 10/00; G06Q 10/06

(52) U.S. Cl. CPC G06Q 10/20; G06Q 10/06314

(57) ABSTRACT

A computer-implemented method includes identifying a plurality of services for a machine. Each of the plurality of services has a service type, and the service type includes an interval service and an independent service. The method includes receiving an input indicative of a usage history of the machine and determining, based on at least one of the service type and the usage history, an estimated due date for each of the plurality of services. The method includes displaying service identifiers, each of which represents one of the plurality of services and indicates the service type, wherein a location of each of the service identifiers along a date axis corresponds to the estimated due date of the at least one of the plurality of services indicated by the service identifier. The location of each of the service identifiers along a service axis corresponds to the service type.

### TECHNICAL FIELD

This disclosure relates generally to fleet and asset management and, more specifically, to systems and methods for monitoring and managing maintenance of a fleet.

### BACKGROUND

Scheduling and conducting regular maintenance of a machine may decrease downtime and extend the life of the machine. In some instances, the need to conduct maintenance on a machine is dependent on a number of factors, including the operating hours of the machine. In addition to regularly scheduled maintenance, machines may also require repairs and other services during the lifetime of the machine. When managing a large fleet of machines, tracking, scheduling, and conducting maintenance in a timely manner is further complicated by finite resources. Thus, it may be desirable to reschedule services for one machine based on the upcoming services for other machines in a fleet. For example, it may be advantageous to reschedule services so that multiple machines receive the same service on the same day, for example, if grouping the services will increase efficiency. Additionally or alternatively, depending on the usage demands on a fleet, it may be desirable to delay or expedite services on machines to maintain the necessary number of machines working on a given project.

One attempt to manage fleet maintenance is described in U.S. Pat. No. 7,016,774 (“the '774 patent”). The '774 patent is directed to a computer-implemented, Internet-based method and system for scheduling the servicing of a fleet of vehicles, each requiring the performance of service operations according to predetermined repair and maintenance schedules. The method described in the '774 patent includes compiling databases of information relating to the items of equipment, the service operations to be performed on them, and service facilities capable of performing the service operations. The '774 patent discloses using a matching system to identify, from the compiled information, matches for equipment, a required service operation, and the availability of service facilities for performing the service operation. Next, the '774 patent teaches selecting from the matches a facility capable of performing the service operation and scheduling the service for that equipment at that facility at time the facility is available.

The method and system provided by the '774 patent may be subject to a number of possible drawbacks. For example, the '774 patent does not provide functionality to estimate, based on past usage history, maintenance intervals for a machine. Further, the '774 patent does not provide the ability to visualize different services for a machine for a user to distinguish, at a glance, different types of services.

The presently disclosed systems and methods are directed to mitigating or overcoming one or more of the problems set forth above and/or other problems in the art.

### SUMMARY

In accordance with one aspect, the present disclosure is directed to a computer-implemented method. The method may include identifying a plurality of services for a machine. Each of the plurality of services may have a service type, and the service type may include at least an interval service and an independent service. The method may include receiving an input indicative of a usage history of the machine and determining, based on at least one of the service type and the usage history, an estimated due date for each of the plurality of services. The method may also include displaying, via a user interface, service identifiers. Each service identifier may represent at least one of the plurality of services and may be indicative of the service type, wherein a location of each of the service identifiers along a date axis corresponds to the estimated due date of the at least one of the plurality of services indicated by the service identifier, and wherein the location of each of the service identifiers along a service axis corresponds to the service type.

According to another aspect, the present disclosure is directed to a computer-implemented method. The computer-implemented method may include identifying a plurality of services for a first machine and a plurality of services for a second machine, each of the plurality of services having a service type. The method may include generating a fleet level view. The fleet level view may be configured to display first service identifiers representing the first plurality of services, the first service identifiers being displayed at locations corresponding to first due dates along a date axis and corresponding to the first machine along a machine axis. The fleet level view may also be configured to display second service identifiers representing the second plurality of services, the second service identifiers being displayed at locations corresponding to second due dates along the date axis and corresponding to the second machine along the machine axis. The method may include receiving a user input for selecting at least one of the first service identifiers. The method may also include generating a machine level view configured to display the first service identifiers at locations corresponding to the first due dates along a date axis and corresponding to the service type along a service type axis. The service type may include an interval service and an independent service.

According to yet another aspect, the present disclosure is directed to a system. The system may a user input, a user output, and a processor. The processor may be configured to identify a first plurality of services for a first machine and a second plurality of services for a second machine. Each of the plurality of services may have a service type. The processor may be configured to generate a fleet level view. The fleet level view may be configured to display, via the user output, first service identifiers representing the first plurality of services, wherein the first service identifiers may be displayed at locations corresponding to first due dates along a date axis and corresponding to the first machine along a machine axis. The fleet level view may also be configured to display, via the user output, second service identifiers representing the second plurality of services, wherein the second service identifiers may be displayed at locations corresponding to second due dates along the date axis and corresponding to the second machine along the machine axis. The processor may be configured to receive a query, via the user input, selecting at least one of the first service identifiers. The processor may also be configured to generate a machine level view via the user output, wherein the machine level view may be configured to display the first service identifiers at locations corresponding to the first due dates along a date axis and corresponding to the service type along a service type axis. The service type may include an interval service and an independent service.

### BRIEF DESCRIPTION OF THE DRAWINGS

FIG. 1 is a diagrammic representation of a an exemplary embodiment of a system for managing maintenance of a fleet.

FIG. 2 is a schematic of a user interface illustrating a fleet level view.

FIG. 3 is a schematic of an exemplary embodiment of a user interface illustrating a fleet level view with an additional information window.

FIG. 4 is a schematic of an exemplary embodiment of a user interface illustrating a machine level view.

FIG. 5 is a flowchart of an exemplary embodiment method for managing maintenance of a machine.

FIG. 6 is a flowchart of an exemplary embodiment of a method for managing maintenance of a fleet having at least two machines.

### DETAILED DESCRIPTION

Reference will now be made in detail to the exemplary embodiments implemented according to the disclosure, the examples of which are illustrated in the accompanying drawings. Wherever possible, the same reference numbers will be used throughout the drawings to refer to the same or like parts.

Embodiments herein include computer-implemented methods, systems, and user interfaces. The computer-implemented methods may be executed, for example, by at least one processor that receives instructions from a non-transitory computer-readable storage medium. Similarly, systems consistent with the present disclosure may include at least one processor and memory, and the memory may be a non-transitory computer-readable storage medium. As used herein, a non-transitory computer-readable storage medium refers to any type of physical memory on which information or data readable by at least one processor may be stored. Examples include random access memory (RAM), read-only memory (ROM), volatile memory, nonvolatile memory, hard drives, CD ROMs, DVDs, flash drives, disks, and any other known physical storage medium. Singular terms, such as “memory” and “computer-readable storage medium,” may additionally refer to multiple structures, such a plurality of memories and/or computer-readable storage mediums. As referred to herein, a “memory” may include any type of computer-readable storage medium unless otherwise specified. A computer-readable storage medium may store instructions for execution by at least one processor, including instructions for causing the processor to perform steps or stages consistent with embodiments herein. Additionally, one or more computer-readable storage mediums may be utilized in implementing a computer-implemented method. The term “computer-readable storage medium” should be understood to include tangible items.

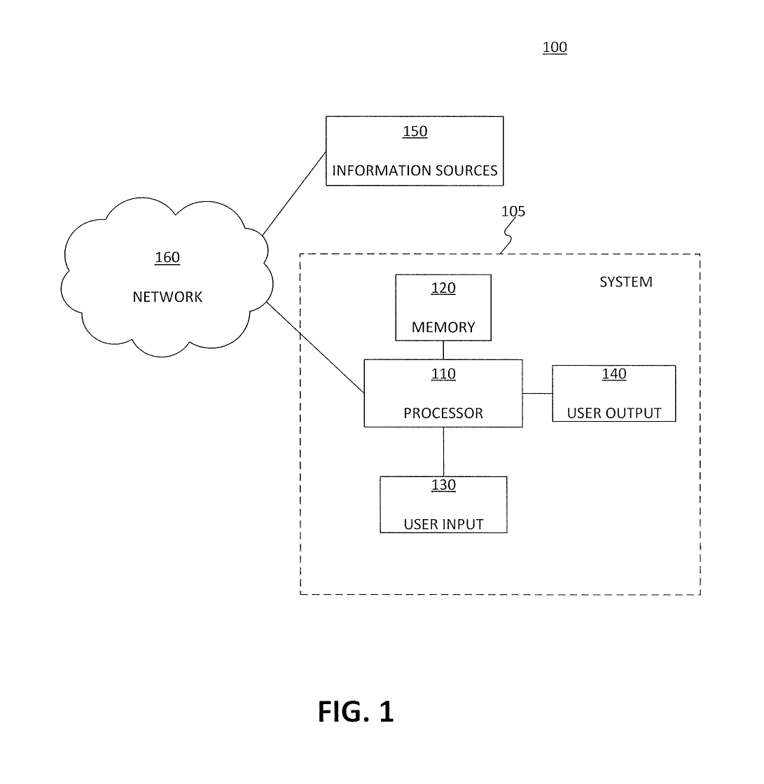

FIG. 1 depicts an exemplary system environment 100 for implementing embodiments of the present disclosure. As shown in FIG. 1, system environment 100 includes a number of components. It will be appreciated from this disclosure that the number and arrangement of these components is exemplary and provided for purposes of illustration. Other arrangements and numbers of components may be utilized without departing from the teachings and embodiments of the present disclosure.

As shown in FIG. 1, the exemplary system environment 100 includes a system 105. System 105 may include one or more server systems, databases, and/or computing systems configured to receive information from entities over a network, process and/or store the information, transmit the information to other entities, and display information. In one exemplary embodiment, system 105 may include a processor 110, memory 120, a user input 130, and a user output 140, which are illustrated in a region bounded by a dashed line for system 105 in FIG. 1.

In some embodiments, system 105 may transmit and/or receive data to/from various other components, such as information sources 150. More specifically, system 105 may be configured to receive and store data transmitted over an electronic network 160 (e.g., comprising the Internet) from various information sources 150, process the received data, and output certain data through user output 140.

The various components of system environment 100 may include an assembly of hardware, software, and/or firmware, including a memory, a central processing unit (CPU), and/or a user interface. Memory may include any type of RAM or ROM embodied in a physical storage medium, such as magnetic storage including floppy disk, hard disk, or magnetic tape; semiconductor storage such as solid state disk (SSD) or flash memory; optical disc storage; or magneto-optical disc storage. A CPU may include one or more processors for processing data according to a set of programmable instructions or software stored in the memory. The functions of each processor may be provided by a single dedicated processor or by a plurality of processors. Moreover, processors may include, without limitation, digital signal processor (DSP) hardware, or any other hardware capable of executing software. An optional user interface may include any type or combination of input/output devices, such as a display monitor, keyboard, and/or mouse.

As described above, system 105 may be configured to receive data over an electronic network 160, process and analyze the data, and display the data via user output 140. For example, system 105 may receive fleet maintenance data from information sources 150, user input 130, and/or elsewhere on electronic network 160.

In accordance with certain embodiments, system 105 may include one or more processors 110, which may be configured to transmit data over electronic network 160 to and from information sources 150. In one embodiment, each processor 110 may store data received from information sources 150 in memory 120. Memory 120 may be any suitable combination of large scale data storage devices, which may optionally include any type or combination of slave databases, load balancers, dummy servers, firewalls, back-up databases, and/or any other desired database components. Each processor 110 may also access data stored in memory 120 in order to process queries received from user input 130. For example, processor 110 may access from memory 120 fleet maintenance data and information related to display preferences for user output 140. After processing a query received from user input 130, processor 110 may transmit the results to user output 140.

It will be appreciated that any suitable configuration of software, processors, and data storage devices may be selected to implement the components of system environment 100 and features of related embodiments. The software and hardware associated with system environment 100 may be selected to enable quick response to various business needs, relatively fast prototyping, and delivery of high-quality solutions and results. An emphasis may be placed on achieving high performance through scaling on a distributed architecture. The selected software and hardware may be flexible, to allow for quick reconfiguration, repurposing, and prototyping for research purposes. The data flows and processes described herein are merely exemplary, and may be reconfigured, merged, compartmentalized, and combined as desired. The exemplary modular architecture described herein may be desirable for performing data intensive analysis. A modular architecture may also be desired to enable efficient integration with external platforms, such as content analysis systems, various plug-ins and services, etc. Finally, the exemplary hardware and modular architecture may be provided with various system monitoring, reporting, and troubleshooting tools.

In accordance with certain embodiments, the components of system 105, such as processor 110 and memory 120, may perform various methods for providing fleet maintenance information via a user interface of user output 140. Processor 110 may be configured to conduct methods or processes to manage maintenance of a machine or a fleet of machines. Thus, a user may employ system 105 to review, schedule, and confirm that all maintenance for a fleet is being properly attended to.

Machines may include any mechanical, electromechanical, or electric device that may be subject to repairs and/or tune-ups during the lifetime of the machine. For example, machines may include land vehicles. For example, a machine may be any type of ground-borne vehicle, such as, for example, an automobile, a truck, an agricultural vehicle, and/or a construction vehicle, such as, for example, a dozer, a skid-steer loader, an excavator, a grader, an on-highway truck, an off-highway truck, and/or any other vehicle type known to a person skilled in the art. In addition to self-propelled machines, machines may be any device configured to travel across terrain via assistance or propulsion from another machine. Additionally or alternatively, machines may include products that are not used to transport payloads, including generators and power tools. Machines can additionally or alternatively include components of a larger machine. For example, a machine may include a transmission system of a vehicle. A fleet of machines may include machines of a similar type, such as a fleet of earth-moving equipment, and/or fleets may include machines operating on the same work site.

Machines may need maintenance during the lifetime of operation. For example, a vehicle may regularly need oil changes and tune-ups to maintain the performance and extend the lifetime of the vehicle. These types of services, those that are regularly conducted, have a service type called “interval service,” and are also referred to as interval services. A machine may have multiple layers of interval services. For example, a vehicle may need the oil changed every 2000 hours, the transmission flushed every 4000 hours, and the spark plugs replaced every 8000 hours. The oil change may be a first-degree interval, and the transmission flush may be a second-degree interval. Similarly, the spark plugs may be a third-degree interval. Under this scheme, the Nth-degree intervals require performance of all of the services in the lower intervals, from the first-degree interval to the (N−1)th-degree interval. Using the oil change, transmission flush, and spark plugs as an example, it may be desirable to perform the oil change at 2000 hours, 4000 hours, 6000 hours, and 8000 hours. Likewise, it may be desirable to perform the transmission flush at 4000 hours and 8000 hours, and it may be desirable to change the spark plugs at 8000 hours. Thus, at the second-degree interval, 4000 hours, it may be desirable to perform the first-degree service (e.g., oil change) and the second-degree service (e.g., transmission flush). At the third-degree interval, 8000 hours, it may be desirable to perform the first, second, and third-degree services (e.g., oil change, transmission flush, spark plug replacement). Interval services may be related to one another in that the interval services regularly occur and the different degrees of intervals may regularly overlap so that the due date for an Nth degree interval service coincides with the due date to perform all (N−1)th to first-degree intervals.

Machines may also require services or repairs that are conducted regularly but independent of other services. For example, it may be desirable to check tire pressure of a machine every month, or every 700 hours. These types of services may be conducted on a regular basis, rather than in response to a component failure. These types of services may be referred to as “independent services.”

Another service type is a backlog repair. A backlog repair of a machine fixes, replaces, or otherwise repairs a broken or malfunctioning component. Backlog repairs may include small repairs, such as replacing a windshield, or more costly repairs, such as replacing an inoperable engine. In some instances, backlog repairs may be scheduled for some time in the future, such as if the broken/malfunctioning component does not interfere with normal operation of machine. For example, it may be advantageous or desirable to replace a broken radio communication system at a later date when machine is not required to be used at a particular worksite, if a broken radio communication system will not render the machine unsafe to operate.

Because the size or cost (e.g., in dollars, manpower, or machine downtime) may affect when it is preferable to schedule a service, it may be desirable to label a service as requiring a major component maintenance. The characterization will depend on the demands on a fleet and a machine within the fleet. For example, if a fleet operates at near 100% all of the time, a service that will require downtime of a machine for an entire workday may be labeled as a major component maintenance. Labeling services as impacting major components also provides notice to the user or fleet manager that the service will require a large product order, additional manpower, or backup machines to keep a fleet meeting its desired output.

A given service may have one or more service types. For example, a transmission replacement that occurs once during the expected lifetime of a machine may be an independent service and a major component service.

A machine may have a maintenance profile identifying a plurality of services the machine is expected to have over the course of its lifetime. For example, the maintenance profile may be prepopulated with services based on the product type of machine. The maintenance profile may also include other services, such as those input by user to address specific issues of a given machine. Storing and tracking a plurality of services for a fleet and for machines that make up the fleet may simplify fleet maintenance. The maintenance profile may optionally include additional information about the plurality of services, including product lists, for example, for replacement parts used to complete the service. The additional information may also include instructions for executing the service. This may be advantageous for fleets that are serviced by members of the operating team, rather than outsourced to a repair shop.

According to some embodiments, processor 110 may be configured to determine a due date for a service. Some services may be scheduled periodically based on a date, such as a service conducted annually. Some services may be scheduled based on a parameter other than a predetermined calendar date. For example, some services may be scheduled based on the usage history of the machine. For example, a service may be required after the machine has operated for a certain number of hours. Other parameters may be useful. Services may be scheduled based on the amount of miles traveled, the amount of fuel consumed, the output of a machine, or any other parameter. This may be particularly advantageous for machines that are not used regularly, such as seasonal equipment. While these parameters may, in some circumstances, more nearly approximate a machine's need for servicing, scheduling these types of repairs is more difficult, as it may require estimating a date to schedule a repair based on the usage of a machine. Thus, a system for tracking usage of machines to predict and/or schedule services may be desirable.

Thus, in addition to identifying the service type of a service, it may be desirable to provide a method of determining a due date for a service. This may be accomplished by considering the usage history of a machine. For example, for some machines, it may be easy to predict the number of days it will take to complete a given number of operating hours by looking at the operating hours of the machine over an earlier timeframe. For example, if a machine is used regularly throughout the year, but the amount of usage varies month-to-month, it may be advantageous to consider the amount of usage hours the machine had in October 2013 to estimate how many usage hours machine will have in October 2014. For other applications, it may be desirable to review the usage history of a machine over the past few weeks. The relevant time frame to predict usage of a machine, and therefore upcoming due dates for services for the machine, may depend upon the fleet or the particular application of a machine. Thus, processor 110 may be configured to adjust a machine cycle, which is the time period of the usage history of the machine that is considered for determining a due date based upon a user input. For example, a fleet manager may adjust the time period to look at the past two weeks if he or she anticipates the usage of the machine will remain constant in the near future. For later scheduled services, such as those that are still thousands of hours away, it may be more desirable to consider a year-long time period when predicting these later dates.

In addition to estimating due dates, monitoring and tracking all of this information for a fleet of machines or even for a single machine may be unwieldy without tools to track this information. Thus, system 105 may be used to manage fleet maintenance and maintenance of a machine.

System 105 may identify a plurality of services for a first machine and a plurality of services for a second machine. For example, system 105 may receive a maintenance profile for a first and a second machine from information source 150. Using this information, processor 110 may be configured to generate a fleet level view via user output 140.

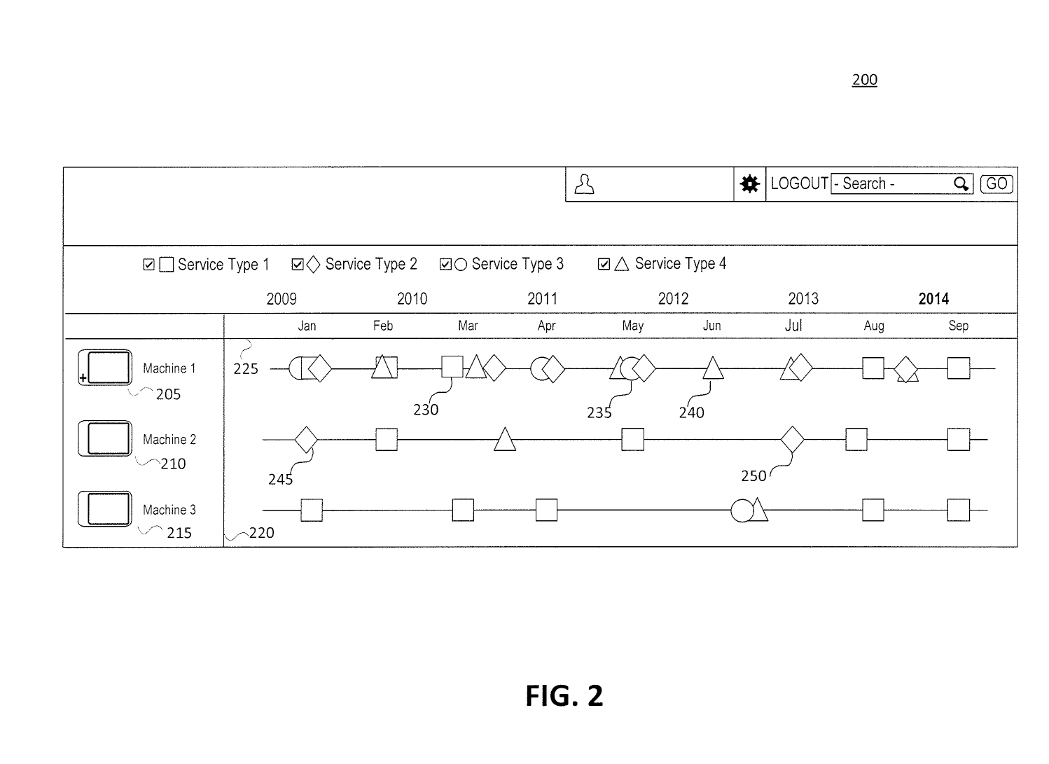

FIG. 2 illustrates an exemplary fleet level view 200. In this view, information regarding a subset or all of the machines in a fleet may be visible. For example, a first machine 205 and a second machine 210 may be represented in fleet level view 200. Fleet level view 200 may include other machines, such as a third machine 215. Each of machines 205, 210, and 215 may be represented along a machine axis 220. In the exemplary embodiment of FIG. 2, machine axis 220 may be a vertical axis. Fleet level view 200 may also include a date axis 225. In the exemplary embodiment of FIG. 2, date axis 225 may be a horizontal axis. The relative orientations of machine axis 220 and date axis 225 may be different. For example, they may be reversed. Machine axis 220 and/or date axis 225 may be labeled or unlabeled. Exemplary date axis 225 in FIG. 2 includes month and year labels. Exemplary machine axis 220 includes icons and machine names for each machine 205, 210, and 215. Machine axis 220 and/or date axis 225 may be adjustable, such as in response to user request via user input 130. For example, it may be desirable for a user to be able to scroll horizontally and/or vertically to review additional machines and/or dates. Further, the date range and/or machine range viewable may be adjusted. For example, exemplary fleet level view 200 displays a nine-month view. However, date axis 225 may be adjusted or modified to show a weekly or even daily view. Fleet level view 200 may be configured to be adjusted according to the preferences or input of a user.

Fleet level view 200, such as that generated by processor 110, may be configured to display service identifiers 230 representative of the services for one or more machines 205, 210, and 215. The location and other visual characteristics of the service identifiers may be indicative of information related to the services, so that a user can quickly recognize different types of services. The characteristics of the views are discussed with reference to fleet level view 200, but some of the functionality discussed herein may be incorporated into other views.

For example, first service identifiers 230, 235, and 240 may correspond to services for machine 205. The locations of first service identifiers 230, 235, and 240 along date axis 225 may correspond to the due dates for each of the services represented by first service identifiers. Further, the locations of first service identifiers 230, 235, and 240 in the first row along machine axis 220 may indicate that first service identifiers 230, 235, and 240 correspond to first machine 205. Likewise, second service identifiers 245 and 250 may correspond to services for machine 210. The locations of second service identifiers 245 and 250 along date axis 225 may correspond to due dates for each of the services represented by second service identifiers 245 and 250. Further, the locations of second service identifiers 245 and 250 in the second row along machine axis 220 may indicate that second service identifiers 245 and 250 correspond to second machine 210.

Each of the first service identifiers 230, 235, and 240 and second service identifiers 245 and 250 may indicate the service type for the service represented by that identifier. For example, first service identifiers 230, 235, and 240 and second service identifiers 245 and 250 all of an interval service type may share a visual characteristic, such as a common shape, color, or texture. Likewise, first service identifiers 230, 235, and 240 and second service identifiers 245 and 250 all of an independent service type may share a visual characteristic, such as a common shape, color, or texture. Further, first service identifiers 230, 235, and 240 and second service identifiers 245 and 250 all of a backlog repair type may share a visual characteristic, such as a common shape, color, or texture. Similarly, first service identifiers 230, 235, and 240 and second service identifiers 245 and 250 all of a major component maintenance type may share a visual characteristic, such as a common shape, color, or texture.

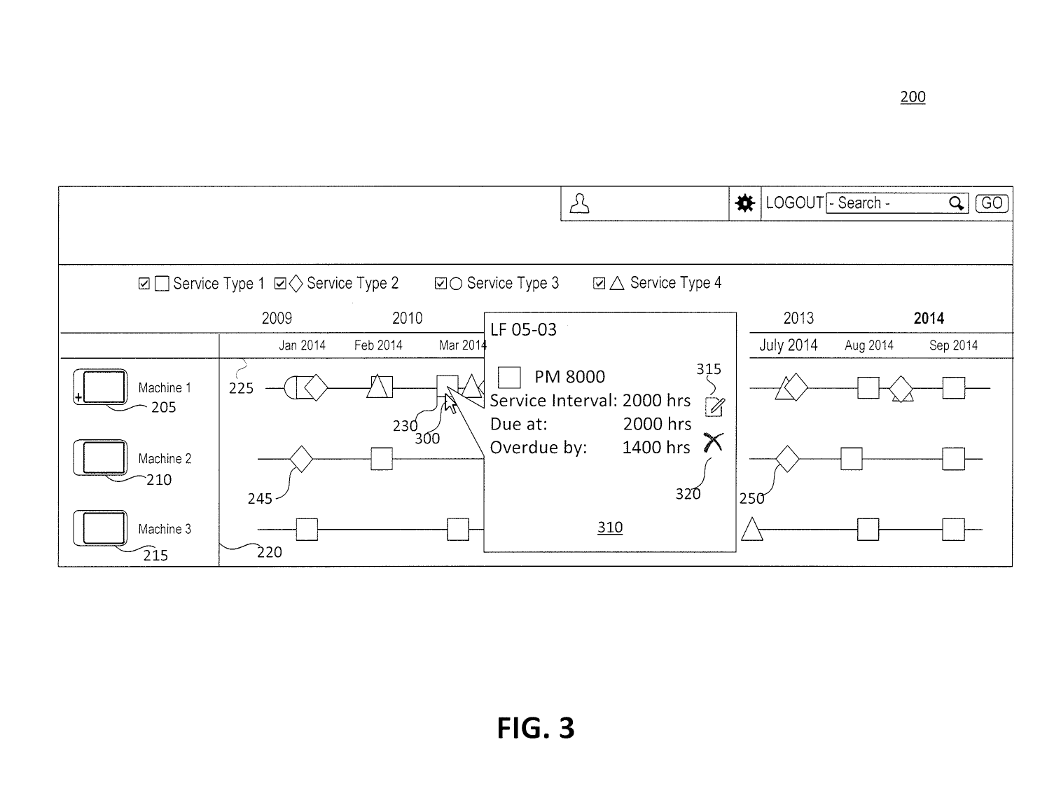

For example, in FIG. 3, first service identifier 230 indicates by its shape that it is an independent service. By its location, first service identifier 230 indicates that it is a service for first machine 205 due in approximately late February/early March of 2014. Further, in FIG. 2, major component maintenance services are represented by circular icons, such as first service identifier 235, and backlog repairs are represented by triangular icons, like first service identifier 240. As another example, second service identifiers 245 and 250 are representative of interval services, schedule to be due approximately six months apart in January and July 2014, and represent their service type with the diamond shape.

FIG. 3 provides an exemplary representation of additional information about the service that may be represented by first service identifier 230. In some circumstances, a user may want to view more detailed information about a particular machine. So, in response to a user query, as represented in FIG. 3 as a hovering cursor 300, fleet level view 200 may be configured to generate a second window 310 displaying information about the service represented by first service identifier 230. This information may include, for example, more details regarding the due date and type of service, instructions for completing the service, and a list of products to be used to complete the service. Fleet level view 200 and second window 310 may be configured to allow a user to edit the information, such as by selecting icon 315 or deleting first service identifier 230 by selecting the delete icon 320.

System 105 may be further configured to enable a user to reschedule a service by moving first service identifier 230, 235, and 240 associated with the service along date axis 225. For example, system 105 may be configured to receive a drag-and-drop input via user input 130. Fleet level view 200 may be further configured to enable a user to enter a more detailed view of the services for first machine 205.

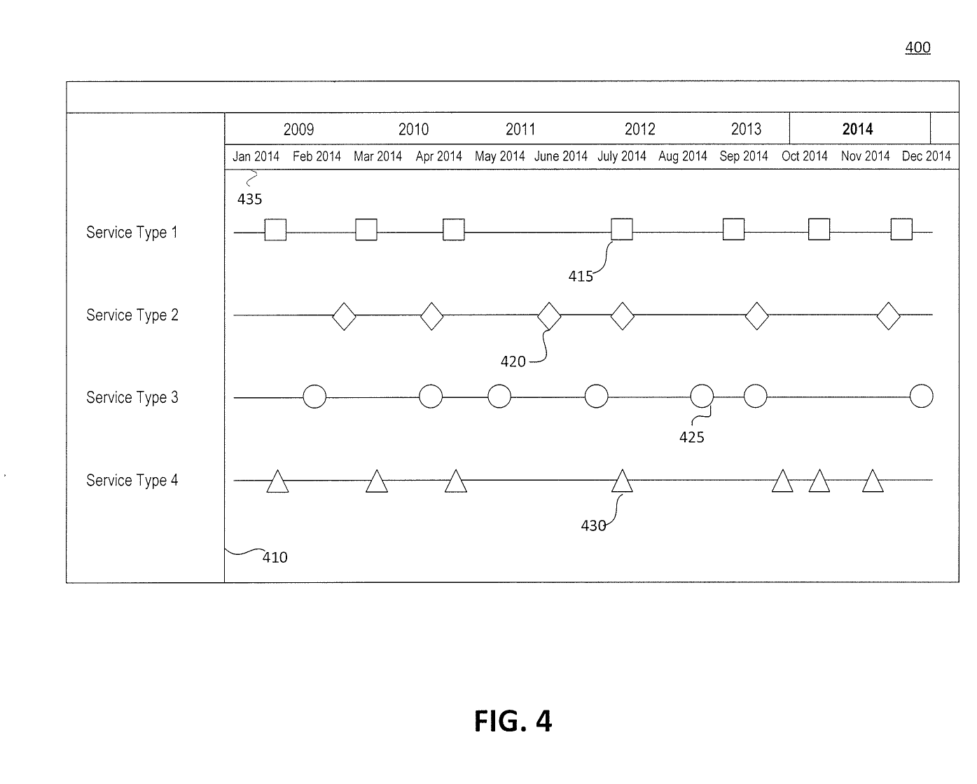

FIG. 4 illustrates an exemplary machine level view 400. Machine level view 400 is similar to fleet level view 200, except that first level service identifiers are arranged along a service type axis 410 rather than a machine axis, and only services for one machine are represented in machine level view 400. Like fleet level view 400, the shape, color, or texture of service identifiers 415, 420, 425, and 430 are indicative of the type of service. Like in fleet level view 200, in machine level view 400, locations of service identifiers 415, 420, 425, and 430 along a date axis 435 correspond to the due dates of the services represented by service identifiers 415, 420, 425, and 430.

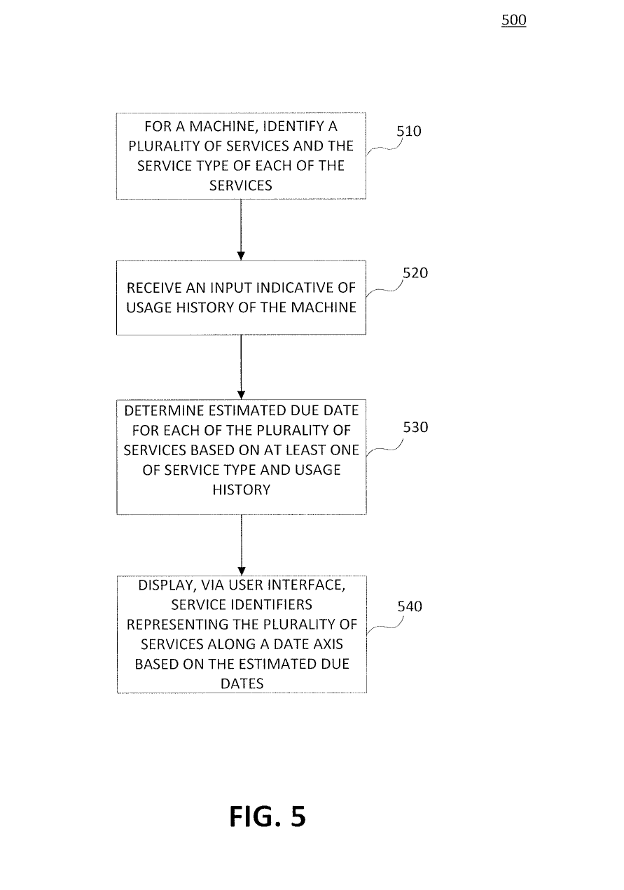

FIG. 5 is an exemplary flow chart of an exemplary method 500 that may be implemented by processor 110 for managing maintenance of first machine 205. At step 510, the method may include identifying a plurality of services for a machine. Each of the plurality of services may have a service type. The service type may be, as discussed above, one or more of an interval service, independent service, backlog repair, and major component maintenance.

At step 520, the method may include receiving an input indicative of a usage history of the machine. This input may be received through network 160. It may optionally be sourced directly or indirectly from sensors or systems of the machine itself. Additionally or alternatively, the information may come from a database or other type of information source 150.

Processor 110 or system 105 may determine, at step 530, an estimated due date for each of the plurality of services based on at least one of the service type and the usage history of machine 205. The usage history of machine 205 may include the entire usage history or be limited to a specific time period, such as a time period selected by a user via user input 130. The estimated due date may be determined by extrapolating past usage history into the future.

At step 540, system 105 may display, via user output 140, service identifiers 415, 420, 425, and 430 for machine 205. Each service identifier 415, 420, 425, and 430 may represent at least one of the plurality of services and indicate the service type of that service. The location of each of the service identifiers 415, 420, 425, and 430 along date axis 435 corresponds to the estimated due date of the at least one of the plurality of services represented by each of service identifiers 415, 420, 425, and 430. Further, the location of each of the service identifiers 415, 420, 425, and 430 along service type axis 410 corresponds to the type of service represented by each of service identifiers 415, 420, 425, and 430.

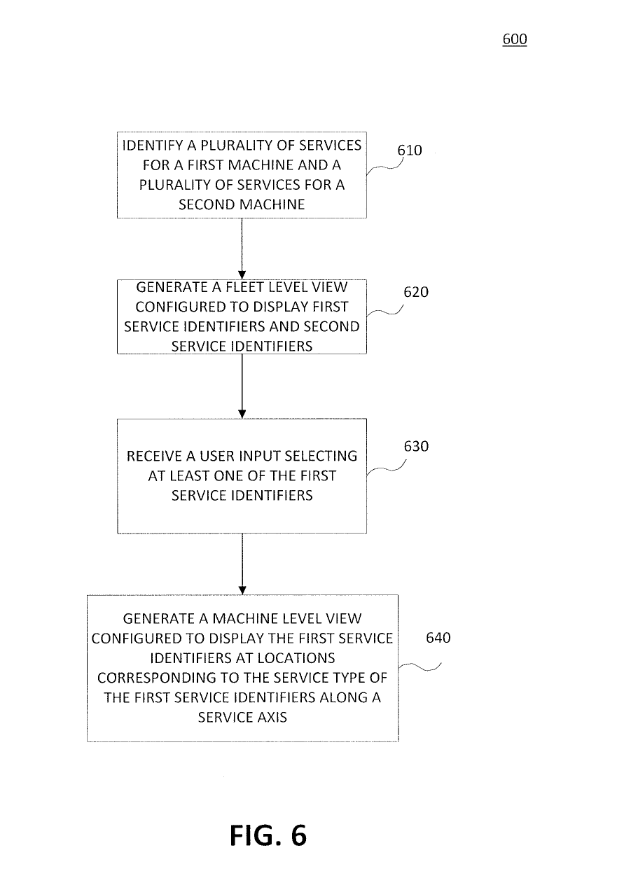

FIG. 6 is an exemplary flow chart for an exemplary method 600 that can be implemented by processor 110. The method may be used for managing maintenance of a fleet, wherein a fleet includes a first machine 205 and a second machine 210. At step 610, the method may include identifying a first plurality of services for a first machine 205 and identifying a second plurality of services for a second machine 210. Each of the plurality of services may have a service type. The service type may be, as discussed above, one or more of an interval service, independent service, backlog repair, and major component maintenance.

At step 620, processor 110 may be configured to generate fleet level view 400, which may be configured to display first service identifiers 230, 235, and 240 and second service identifiers 245 and 250 along date axis 225 and machine axis 220. The location along date axis 225 of each of first service identifiers 230, 235, and 240 and second service identifiers 245 and 250 may correspond to a due date for each of the first plurality of services and second plurality of services corresponding to that identifier. The location along machine axis 220 of each of first service identifiers 230, 235, and 240 may correspond to first machine 205 and the location of second service identifiers 245 and 250 along machine axis 220 may correspond to second machine 210.

At step 630, processor 110 may be configured to, in response to a user input selecting at least one of first service identifiers 230, 235, and 240, generate machine level view 400. Machine level view 400 may display, via user output 140, first service identifiers 230, 235, and 240 for first machine 205. Each first service identifiers 230, 235, and 240 may represent at least one of the plurality of services and indicate the service type of that service. The location of each of first service identifiers 230, 235, and 240 along date axis 435 corresponds to the estimated due date of the at least one of the plurality of services represented by each of first service identifiers 230, 235, and 240. Further, the location of each of the first service identifiers 230, 235, and 240 along service type axis 410 corresponds to the type of service represented by each of service identifiers 415, 420, 425, and 430.

### INDUSTRIAL APPLICABILITY

The disclosed system and methods may provide a robust solution for managing maintenance of a fleet of machines. The disclosed systems and methods for fleet management may allow fleet managers and dealers to schedule and manage maintenance on both the fleet and machine level, thereby providing the data and visualization to increase the efficiency of maintenance schedules.

The presently disclosed systems and methods may have several potential advantages. For example, the presently disclosed systems and methods provide variable methods for estimating a due date for a service. As regular services are scheduled based on the amount of operating hours, fuel, output, or mileage of a machine, it may not be easy as scheduling services on a date-based cycle (e.g., every three months). Since operating hours, fuel, output, and/or mileage of a machine may vary on a daily, weekly, monthly, seasonal, or annual basis, the presently disclosed methods may provide flexibility to estimate upcoming service due dates based on past usage of the machine on multiple cycles. For example, for a machine that is used seasonally, such as a snow plow, it may be more accurate to predict operating hours based on an annual, rather than daily, cycle.

Additionally, the presently disclosed systems and methods provide visualization of maintenance on a fleet level and machine level. Further, the systems and methods provide visual distinctions among different types of services. Providing all of this information at a glance to a user may allow a user to schedule services based upon impending deadlines while considering the requirements of a particular service for that machine as well as the requirements of services for other machines in the fleet.

It will be apparent to those skilled in the art that various modifications and variations can be made to the disclosed systems and associated methods for using the same. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer-implemented method comprising:
identifying a plurality of services for a machine, each of the plurality of services having a service type, the service type including at least an interval service and an independent service;
receiving an input indicative of a usage history of the machine;
determining, based on at least one of the service type and the usage history, an estimated due date for each of the plurality of services; and
displaying, via a user interface, service identifiers, each service identifier representing at least one of the plurality of services and indicative of the service type, wherein a location of each of the service identifiers along a date axis corresponds to the estimated due date of the at least one of the plurality of services indicated by the service identifier and wherein the location of each of the service identifiers along a service axis corresponds to the service type of the service.

2. The method of claim 1, wherein the service type further includes a major component maintenance and a backlog repair.

3. The method of claim 2, wherein each of the service identifiers indicative of an interval service shares at least one of a shape, a color, and a texture.

4. The method of claim 1 wherein the interval service includes a first level interval and a second level interval, wherein the first level interval requires a first maintenance to be performed and a second level interval requires the first maintenance and a second maintenance to be performed.

5. The computer-implemented method of claim 1, wherein the estimated due date is determined based upon a usage history of the machine over a machine cycle.

6. A computer-implemented method comprising:
identifying a plurality of services for a first machine and a plurality of services for a second machine, each of the plurality of services having a service type;
generating a fleet level view configured to:
display first service identifiers representing the first plurality of services, the first service identifiers being displayed at locations corresponding to first due dates along a date axis and corresponding to the first machine along a machine axis;
display second service identifiers representing the second plurality of services, the second service identifiers being displayed at locations corresponding to second due dates along the date axis and corresponding to the second machine along the machine axis;
receiving a user input selecting at least one of the first service identifiers;
generating a machine level view configured to display the first service identifiers at locations corresponding to the first due dates along a date axis and corresponding to the service type along a service type axis,
wherein the service type includes an interval service and an independent service.

7. The computer-implemented method of claim 6, wherein service type further includes at least one of a backlog repair and a major component service.

8. The computer-implemented method of claim 6, wherein each of the first service identifiers and the second service identifiers visually identify its service type by at least one of a shape, a color, and a texture.

9. The computer-implemented method of claim 6, wherein the fleet level view is further configured to, in response to receiving a user query regarding at least one of the first service identifiers, generating a second window displaying information associated with the at least one of the first service identifiers and enabling user input to revise the information associated with the at least one of the first service identifiers.

10. The computer-implemented method of claim 9, wherein the information includes instructions for completing the service.

11. The computer-implemented method of claim 9, wherein the information includes a list of products to be used for completing the service.

12. The computer-implemented method of claim 6, wherein at least one of the fleet level view and machine level view is further configured to enable a user to reschedule one of the first plurality of services by moving the first service identifier associated with the one of the first plurality of services along the date axis.

13. The computer-implemented method of claim 6, wherein the interval service includes a first degree interval and a second degree interval, wherein the second degree interval is inclusive of a service performed for the first degree interval.

14. A system comprising:
a user input;
a user output; and
a processor configured to:
identify a first plurality of services for a first machine and a second plurality of services for a second machine, wherein each of the plurality of services has a service type;
generate a fleet level view configured to display, via the user output, first service identifiers representing the first plurality of services, wherein the first service identifiers are displayed at locations corresponding to first due dates along a date axis and corresponding to the first machine along a machine axis, and display, via the user output, second service identifiers representing the second plurality of services, wherein the second service identifiers are displayed at locations corresponding to second due dates along the date axis and corresponding to the second machine along the machine axis;
receive a query, via the user input, selecting at least one of the first service identifiers; and
generate a machine level view, via the user output, configured to display the first service identifiers at locations corresponding to the first due dates along a date axis and corresponding to the service type along a service type axis,
wherein the service type includes an interval service and an independent service.

15. The system of claim 14, wherein in at least one of the fleet level view and machine level view, the processor is further configured to enable a user to reschedule one of the first plurality of services by moving the first service identifier associated with the one of the first plurality of services along the date axis.

16. The system of claim 14, wherein the processor is further configured to determine the first due dates based upon a usage history of the first machine.

17. The system of claim 16, wherein the processor is further configured to receive from the user input a signal indicative of a time period of the usage history for the first machine and to consider the time period of the usage history to determine the first due dates.

18. The system of claim 14, wherein the service type further includes at least one of a major component maintenance and a backlog repair.

19. The system of claim 14, wherein each of the first service identifiers and each of the second service identifiers indicate its service type by at least one of a color, a shape, and a texture.

20. The system of claim 14, wherein at least one of the fleet level view and the machine level view is further configured to, in response to receiving a user query regarding at least one of the first service identifiers, generate a second window displaying information associated with the at least one first service identifier.
